(19) United States
(12) Patent Application Publication
(10) Pub. No.: US 2007/0083478 A1
(43) Pub. Date: Apr. 12, 2007

(54) Cogeneration implementation simulation method and system, and cogeneration device sail promotion method and system

(75) Inventors: Shigeo Nonoyama, Aichi-ken (JP); Hidehiko Takeda, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/577,143

(22) PCT Filed: Oct. 26, 2004
(86) PCT No.: PCT/JP04/15855

§ 371 Date: Apr. 26, 2006

(30) Foreign Application Priority Data
Oct. 27, 2003 (JP) 2003-365607

(51) Int. Cl. G06F 17/00

(52) U.S. Cl. 705/412; 60/783; 700/288

(57) ABSTRACT

A method and a system suitable for predicting the costs of implementing cogenerations in small-scaled places of business and ordinary homes. Transmitters (3) located at the respective ones of facilities transmit, by radio, data of electric power consumption amounts of the facilities as measured by electric power meters (1) and data of gas consumption amounts of the facilities as measured by gas meters (2), which are received by a receiver (4). Estimation means (5) uses an estimation program to provide, from the received data, cost estimations of a case when cogenerations are implemented in the facilities. Annual cost estimation means provides, from the estimation results of the estimation means (5), annual cost estimations.

### TECHNICAL FIELD

This invention relates to a technology for estimating cost in introducing cogeneration. This invention also relates to a technology for sales promotion in selling equipment used for cogeneration.

### BACKGROUND ART

Cogeneration generally means generation of multi-kind energy such as electricity and heat from one energy source. This field has been attracted much social attention under surging concern to environmental issues such as the global warming and the demand for power efficiency improvement by energy saving. Typical cogeneration is utilization of heat produced in generating electric power. For example, the heat is utilized for heating of housing.

Specifically, one of typical cogeneration is electricity-and-heat co-supply where heat generated from an electric generator is utilized to hot water supply and room heating. In this type of cogeneration, electric power is usually consumed at a site of power generation. Therefore, it has almost no loss in the power transmission, attracting attention in view of high efficiency as well. Cogeneration has been introduced popularly to small-to-medium-sized buildings and factories so far. However, it is expected to be introduced to more-smaller-sized facilities and ordinary houses, since the special maintenance operator disposition was made not mandatory for small-scaled equipment less than 1000 kW in the revision of Electricity Utilities Industry Law in 1995.

Patent reference 1; JP 2002-7523

### DISCLOSURE OF THE INVENTION

One matter in introducing cogeneration is its cost estimation. Even if cogeneration is high energy efficiency and preferable for the global environment, it is undeniable that introductions tend to be heisted when total costs paid by owners exceed current costs. Depending on a utilization situation of electricity and heat, and a price of cogeneration equipment, the total cost after cogeneration introduction could be higher than before, or could be lower. This invention is in consideration of this matter, presenting a method and system preferable for cost estimation of cogeneration introduction to small-sized facilities and ordinary houses, and having the technical meaning of contributing to promotion of cogeneration equipment sale to the small-sized facilities and ordinary houses.

### BRIEF DESCRIPTION OF DRAWINGS

FIG. 1 is a view showing the schematic configuration of a cogeneration introduction simulation system as a mode of the invention.

FIG. 2 is a view showing the schematic configuration of a power measuring unit 10.

FIG. 3 is a view showing the schematic configuration of a gas-flow integration transmission unit 30.

FIG. 4 is a view conceptually showing an example of protocol in a data conversion program.

FIG. 5 is a view showing the schematic configuration of a receiving unit 40.

FIG. 6 is a view showing an example of a facility information table.

FIG. 7 is a view showing an example of data tables.

FIG. 8 is a schematic view showing an example of facility power tables.

FIG. 9 is a schematic view showing an example of facility gas volume tables.

FIG. 10 is a flowchart schematically showing an estimation program.

FIG. 11 is a view showing the schematic configuration of a cogeneration equipment sales promotion system.

### THE BEST MODE FOR CARRYING OUT THE INVENTION

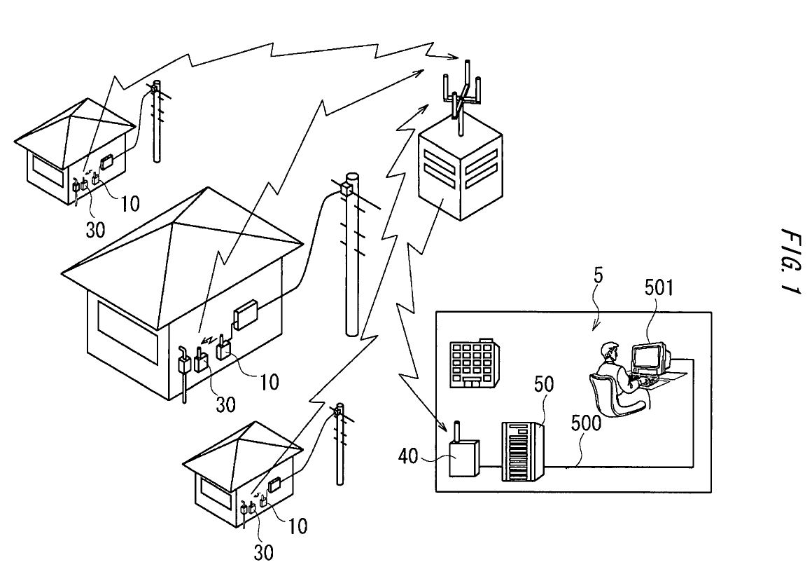

The best mode for carrying out the invention will be described as follows. FIG. 1 is a view showing the schematic configuration of a cogeneration introduction simulation system as a mode of the invention. The system shown in FIG. 1 comprises a wattmeter 1 provided in each facility to measure electric power consumption volume thereof, a gas meter 2 provided in each facility to measure gas consumption volume thereof, a transmitter 3 provided in each facility to radio-transmit data of the power consumption volume measured at the electric power meter 1 and the gas consumption volume measured at the gas meter 2, a receiver 4 to receive the data transmitted from the transmitter 3, and an estimation means 5 to carry out a cost estimation after introduction of cogeneration in each facility.

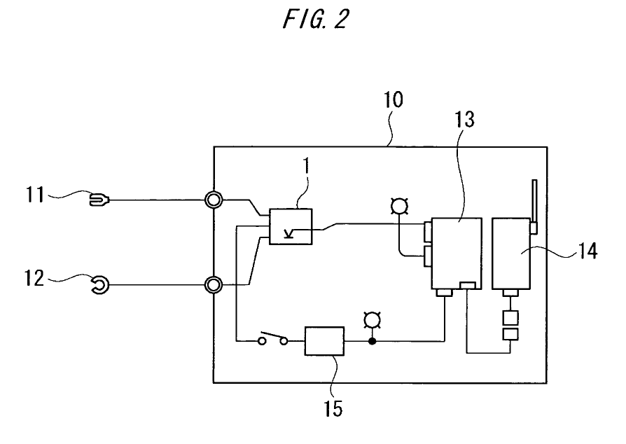

The wattmeter 1 is provided as a component of a power measuring unit 10. FIG. 2 is a view showing the schematic configuration of the power measuring unit 10. The power measuring unit 10 comprises a voltage terminal 11 to be connected to a distribution board in a facility, a current terminal 12 to be connected to the distribution board as well, the wattmeter 1 to measure electric power by an inputted voltage from the voltage terminal 11 and an inputted current from the current terminal 12, and a power integrator 13 to integrate the output of the wattmeter 1. A type outputting watt-hour data in form of pulses is used as the wattmeter 1, such as KUWT of M-System Co., Ltd., Osaka, Japan. In this mode, the pulse output is set to one watt-hour per one pulse. Though this mode employs one single-phase two-wire wattmeter 1, a couple of single-phase wattmeters may be used to measure R-phase component and T-phase component of single-phase three-wire power.

The power integrator 13 comprises an accumulative watt-hour counter continuously integrating the output pulse of the wattmeter 1, and a unit counter carrying out integration per one minute. The power integrator 13 calculates instantaneous power converted to a value in one hour by making the output of the unit counter sixty times. The power measuring unit 10 also comprises a local transmitter 14, which is capable of transmitting output values of the accumulative power counter and calculated values of the instantaneous power. Specified Low-Power Radio (SLPR) or Personal Handyphone System (PHS) can be employed for the local transmitter 14. The power measuring unit also comprises a power supply circuit 15. These components are contained in a unit box, on which an indicator indicating the operation situation is provided.

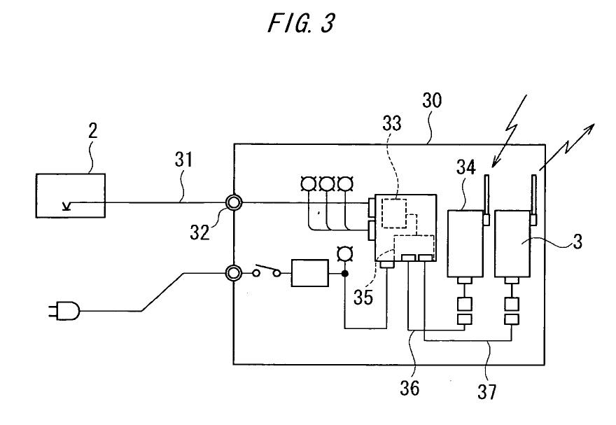

The transmitter 3 is provided as a component of a gas-flow integration transmission unit 30. The schematic configuration of the gas-flow integration transmission unit 30 will be described referring FIG. 3. FIG. 3 is a view showing the schematic configuration of the gas-flow integration transmission unit 30. The gas-flow integration transmission unit 30 is connected to the gas meter 2 by a signal cable 31. The gas meter 2 is one capable of pulse-outputting of gas flow, such as DS-6A of Sinagawa Corporation, Tokyo, Japan. The output in this mode is set at 0.1 liter per one pulse.

The gas-flow integration transmission unit 30 comprises an input terminal 32 with which the signal cable 31 is connected, and a gas integrator 33 to which a signal from the gas meter 3 is inputted via the input terminal 32. The gas integrator 33 has an integration counter integrating the output pulses from the gas meter 2 periodically, e.g., every ten minutes. The gas-flow integration transmission unit 30 comprises a local receiver 34 receiving the radio-transmitted data from the local transmitter 14. The local receiver 34 may be SLPR or PHS as well as the local transmitter 14.

The gas-flow integration transmission unit 30 comprises a transmitting processor 35. The local receiver 34 is connected to the transmitting processor 35 by a signal cable 36 so that data of the counted accumulative power value and the instantaneous power can be inputted to the transmitting processor 35. The transmitting processor 35 is a kind of data processing terminal comprising a CPU, memories (ROM and RAM), and other components. Data of the counted accumulative power and the instantaneous power, the integrated gas volume is memorized in a certain area of the memory (RAM). A program to convert the data of the counted accumulative power, the instantaneous power and the integrated gas volume into a predetermined protocol is installed in the memory (ROM). This program is hereinafter mentioned as “data conversion program”.

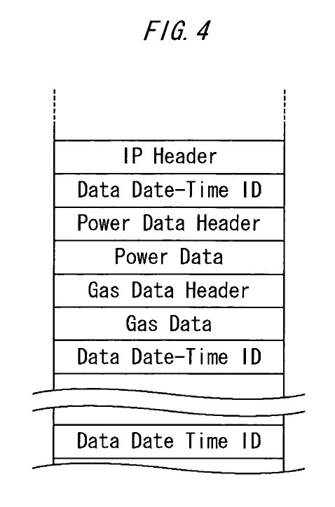

FIG. 4 is a view conceptually showing an example of protocol in the data conversion program. As described later, the telemetry period in this mode is three hours, where the transmission is carried out every three hours. Therefore, the counted accumulative power, the instantaneous power and the integrated gas volume are the data in every three hours. In the example shown in FIG. 4, is provided IP Header at the beginning. The IP Header is a code to identify a facility where data of power and gas volume are measured. Next to the IP Header follows Data Date-Time ID. The Data Date-Time ID is one for showing when those data are obtained, into which date-time information, e.g., “15:00, Aug. 1, 2003”, is encoded. Next to the Data Date-Time ID, is provided Power Data Header pointing that data of the counted accumulated power and the instantaneous power follow. Thereafter, is provided the code of a data body of the counted accumulative power and the instantaneous power, which is hereinafter mentioned as “power data”. Next to this, is provided Gas Data Header pointing that a data of gas volume follows. Then, a data body of the integrated gas volume follows this. The Data Date-Time ID, the Power Data Header, the Power Data, the Gas Data Header and the Gas Data are repeated at required times, e.g., twice. The data encoded according to this protocol are memorized in a certain area of the memory.

The transmitter 3, which is hereinafter mentioned as “global transmitter” to be distinguished from the local transmitter 14, is connected to the transmitting processor 35 by a signal cable 37. The converted and memorized data of the counted accumulative power, the instantaneous power and the integrated gas volume are transmitted to the global transmitter 3 via the signal cable 37, then radio-transmitted out therefrom. In this mode, a PHS terminal capable of telemetry is used as the global transmitter 3. The transmission is carried out by an external channel of PHS. Products suitable for the telemetry-capable PHS terminal and the transmitting processor 35 are on sale from manufacturers. Any one, e.g., WP10 PHS DATA UNIT of Matsushita Electric Works, Ltd. may be employed for this use.

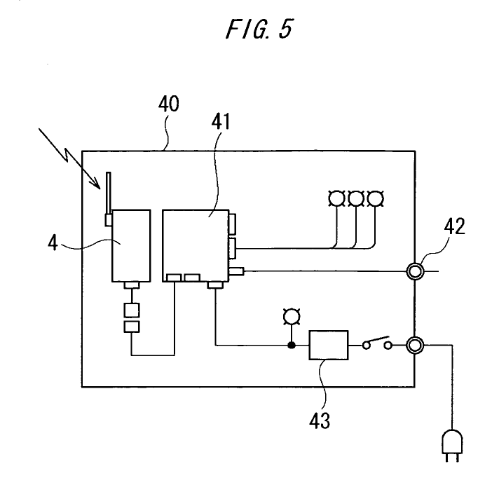

The receiver 4, which is hereinafter mentioned as “global receiver” to be distinguished from the local receiver 34, is provided as a component of a receiving unit 40. FIG. 5 is a view showing the schematic configuration of the receiving unit 40. The receiving unit 40 comprises the global receiver 4, and a receiving processor 41 carrying out data processing such as conversion of data received by the global receiver 4. The global receiver 4 may have essentially the same configuration as the global transmitter 3. A PHS terminal capable of telemetry can be used as the global receiver 4. The receiving processor 41 is a kind of an information terminal comprising a CPU and memories. The described WP10 PHS DATA UNIT of Matsushita Electric Works, Ltd. or any other suitable product may be employed as the member co-functioning as the global receiver 4 and the receiving processor 41.

In the memory (ROM) of the receiving processor 41, is installed a telemetry program (hereinafter, TMP), which carries out telemetry commands according to preset telemetry periods. In the memory of the receiving processor 41, are memorized external numbers of the facilities. In every telemetry period, the TMP recalls the memorized external numbers successively, and makes the global transmitter 3 transmit out the data memorized in memory of the transmitting processor 35, i.e., the counted accumulative power, the instantaneous power and the integrated gas volume. The transmitted data are temporarily memorized in the memory (RAM) of the receiving processor 41. In the memory (ROM), are installed a decoding program to decode the digital signal according to the described protocol, and a transmission program to transmit the decoded data to a data server after converting them into a predetermined-format file. The receiving unit 40 further comprises an interface 42 for transmitting data to the data server and a power supply circuit 43. The interface may be, for example, a RS232C interface, being connected to the data server by a RS232C cable. Otherwise, a LAN interface such as 10/100 BASE-T may be used.

Next will be described the estimation means 5. As shown in FIG. 1, the estimation means 5 comprises the data server 50 to which the data received at the global receiver 4 are inputted, and an administrative client 501 connected to the data server 50 via a LAN 500. The data server 50 is a computer comprising a CPU, memories, a hard disk and other components along a bus line. A database management software (DBMS) is installed in the hard disk in addition to an OS. The DBMS is so-called relational one, such as ACCESS (registered trademark) of Microsoft Corporation or ORACLE (registered trademark) of Oracle Corporation. Further in the hard disk, is installed an estimation program carrying out an estimation of a post-introduction cost of cogeneration in each facility on the basis of data outputted from the global receiver 4.

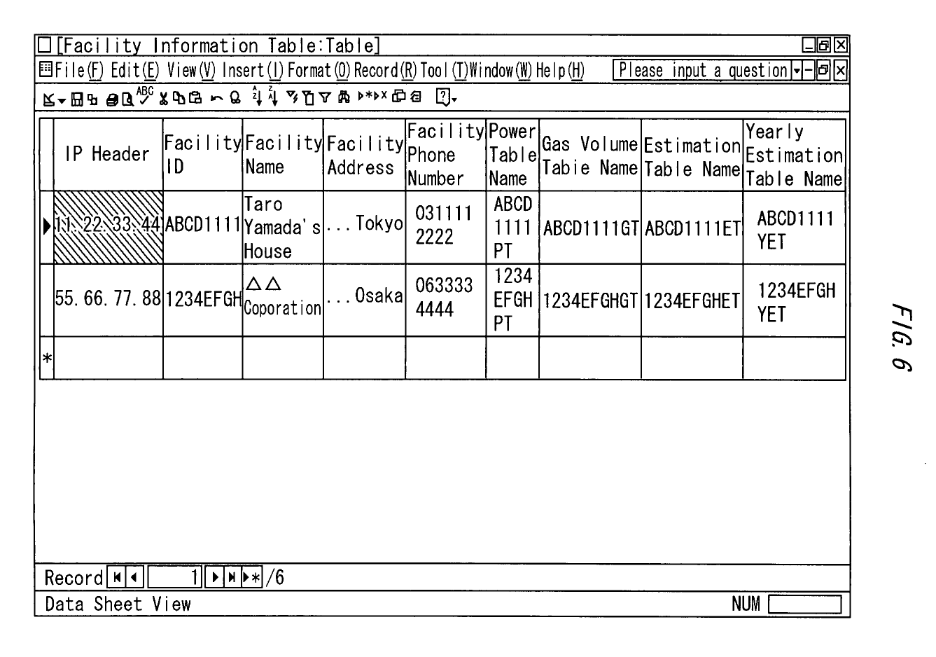

Many object files (OBF) managed by the DBMS are stored in the hard disk. One of OBF is a facility information table. In the facility information table, information of each facility for which post-introduction simulation is carried out is recorded. FIG. 6 is a view showing an example of the facility information table. As shown in FIG. 6, Each of many records registered in the facility information table comprises fields of;

IP Header

Facility ID

Facility Name

Facility Address

Facility Phone Number,

Power Table Name,

Gas Volume Table Name,

Estimation Table Name

Yearly Estimation Table Name.

The Facility ID, which is to identify each facility, is usually composed of alphanumeric characters. Showing an example in a case of company possession, the facility name can be “XX factory of OO Co., Ltd.”, or “head quarter of YY corporation”. As an example of private houses, it can be “Taro Yamada's House”. The IP Header is the same data as in the protocol shown in FIG. 4. The IP Header and the Facility ID are in relation of one-to-one correspondence.

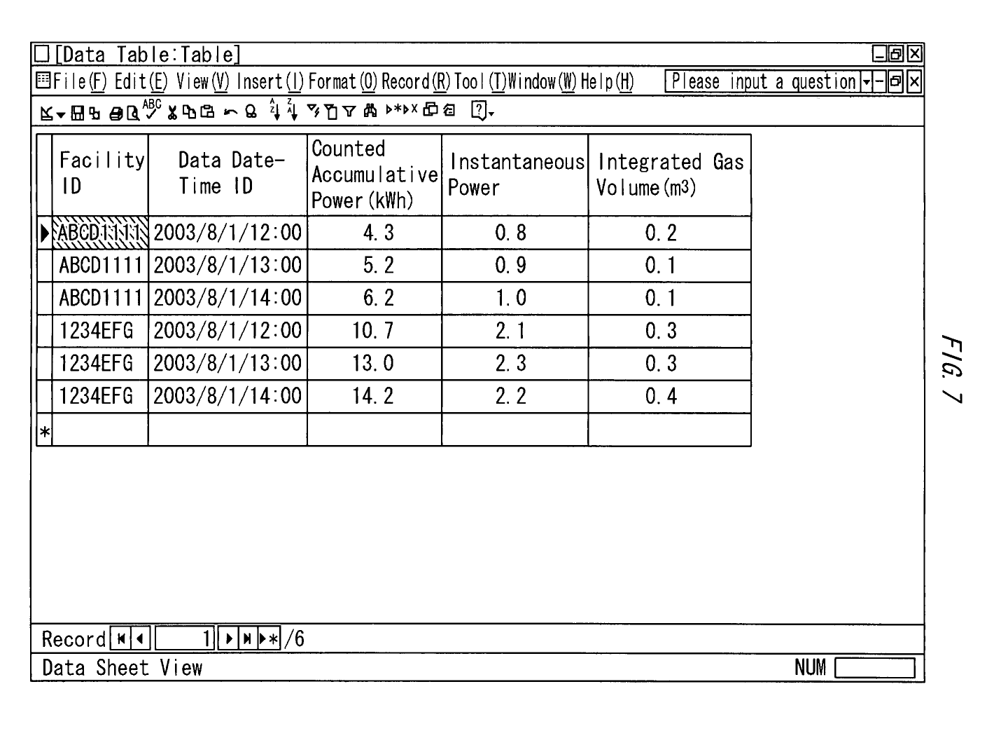

The decoding program and the transmission program both installed in the receiving processor 41 are automatically executed after the TMP is executed. The received data of the counted accumulative power, the instantaneous power and the integrated gas volume is hereinafter just mentioned as “received data”. The decoding program and the transmission program are programmed so that the received data are memorized in a file of such format as CSV at a predetermined path in the hard disk of the data server 50. A received-data registration program (hereinafter, RDRP) is installed in the hard disk of the data server 50. The RDRP converts the memorized received data and registers them into a newly created table. This table where the received data of the facilities are registered by the RDRP is hereinafter just mentioned as “data table”. FIG. 7 is a view showing an example of data tables.

As shown in FIG. 7, records of sampling times, e.g., three, are registered in the data table. Each records is composed of fields of “Facility ID”, “Data Date-Time ID”, “Counted Accumulative Power”, “Instantaneous Power” and “Integrated Gas Volume”. The RDRP searches the facility information table by the IP Header as search key, then gets the counter Facility ID. The RDRP connects the facility information table to the data table by this Facility ID. The RDRP reserves the created data table at a predetermined path in the hard disk. On the other hand, a facility power table and a facility gas volume table are created and reserved in the hard disk of the data server 50 in advance. The facility power table is one where data of the counted accumulated power and the instantaneous power of facilities are collected. The facility gas table is one where data of the integrated gas volume of facilities are collected. A data appending program is installed in the hard disk in advance. The data appending program, hereinafter “DAP”, appends new records in the facility power table and the facility gas volume table, and connects the data in the data table to those appended records.

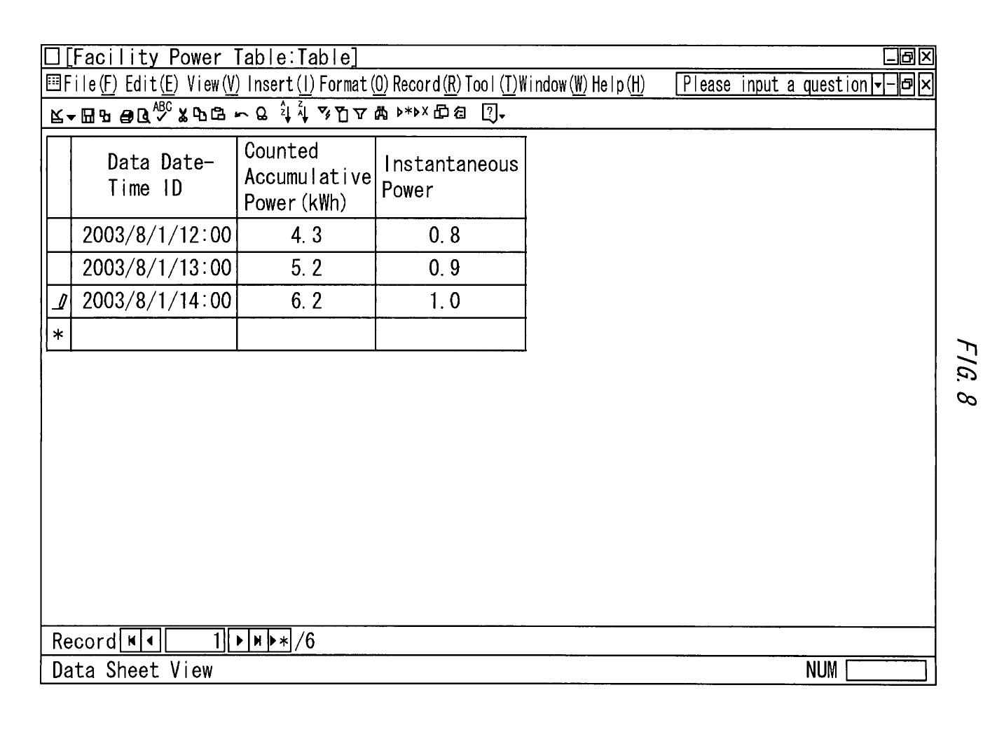

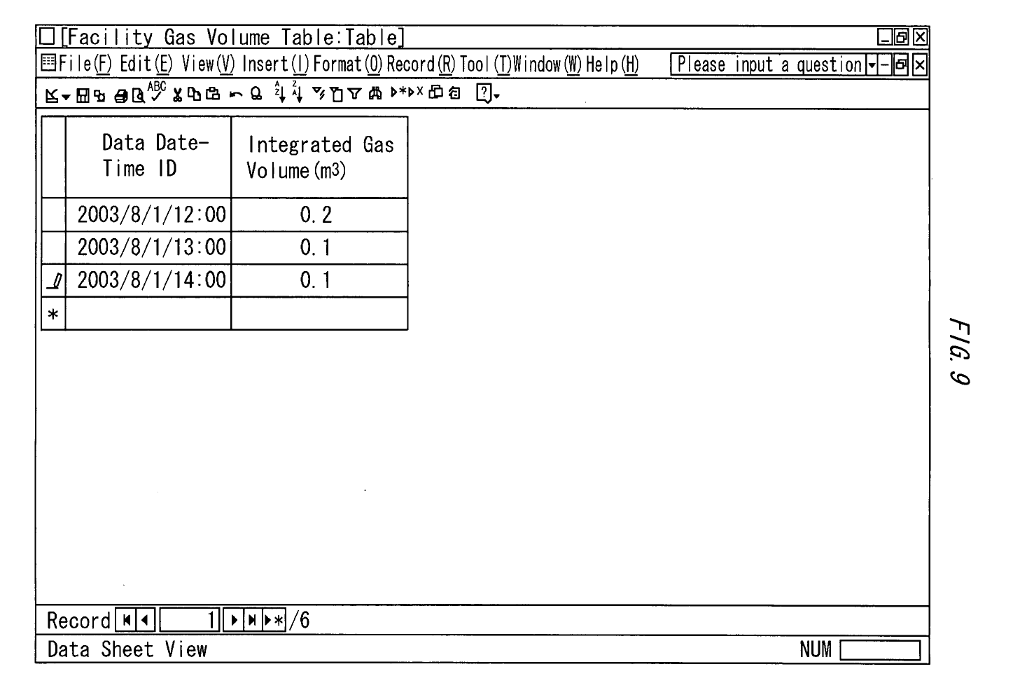

FIG. 8 is a schematic view showing an example of facility power tables. FIG. 9 is a schematic view showing an example of facility gas volume tables. The DAP is automatically executed after the RDRP is executed. As shown in FIG. 8, each of many records registered in the facility power table is composed of fields of “Data Date-Time ID”, “Counted Accumulative Power” and “Instantaneous Power”. The facility power table is created for each facility. Each facility power table is given a table name in relation to the Facility ID respectively. The DAP searches the facility information table by the Facility ID as search key, then obtains a power table name. The DAP appends the data into the facility power table of the obtained power table name. As shown in FIG. 7, records of sampling times, e.g., three, are appended in the facility power table one time.

As shown in FIG. 9, each of many records registered in the facility power table is composed of fields of “Data Date-Time ID”, “Counted Accumulative Power” and “Instantaneous Power”. The facility power table is created for each facility, and given a table name in relation to a Facility ID respectively. As well, the DAP obtains a gas volume table name according to a Facility ID, then appends data of sampling times as new records in the facility gas volume table of the obtained name.

Next will be described the estimation program, which is one of points much characterizing this mode. Cost estimation after introduction of cogeneration equipment is influenced by many factors such as kinds and performance of equipment, situation of usage, and others. The following description is about cost simulation in the case that a small-sized generator generating power by making a gas rotate a turbine is introduced, and exhausted heat thereof is utilized.

Even when the small-sized generator is introduced, usually not all power in the facility is supplied by it. Taking such a matter as failure of the generator into consideration, the contract with a power company is maintained, and a part of power is relied on the supply from the power company. In the following description, “a” is a burden proportion of the introduced generator (0<a<1). That is, the burden proportion of the power supply from the power company is “1−a”. Where the small-sized generator is introduced, there may be the case that a part of the generated power is sold to a power company. When the whole generated power is “P_{co}”, and a proportion of the power sold to the power company is “b” (0≦b<1), then
P_{co}=(1−b)P_{co}+bP_{co}.
(1−b)P_{co} is the home consumption proportion of the generated power.

In the current (pre-introduction) situation, when the basic power rate is E₁ and the volume-based power rate is E₂, then the current total power rate RE_{cu} is expressed as

$$\begin{matrix}R {E}_{cu} = {E}_{1} + {E}_{2} \\ = {E}_{1} + α {P}_{cu} ( {E}_{2} = α {P}_{cu} ) .\end{matrix}$$

α is coefficient for calculating the volume-based power rate. After introducing the cogeneration, because the power supplied form the power company is made (1−a) times compared to the current one, then the post-introduction total power rate RE_{new} is expressed as

$$\begin{matrix}R {E}_{new} = {E}_{1} + ( 1 - a ) {E}_{2} - {E}_{3} \\ = {E}_{1} + ( 1 - a ) α {P}_{cu} - {E}_{3} .\end{matrix}$$

In the above formula, E₃ is a payment for sale of the power to the power company, offsetting the power rate. Assuming the price in selling the power to the power company is completely volume-based, when β is coefficient of it, then the payment E₃ for sale of the power to the power company is expressed as
E₃=βbP_{co}.
Therefore, the post-introduction power rate is expressed as
RE_{new}=E₁+(1−a)αP_{cu}−βbP_{co}.

If power generation by the introduced generator is a completely slaved operation, that is, without consideration of power storage into a battery,
(1−b)P_{co}=aP_{cu}.
Therefore,
P_{co}={a/(1−b)}P_{cu}.
Accordingly, the post-introduction power rate RE_{new} is expressed as

$$\begin{matrix}R {E}_{new} = {E}_{1} + ( 1 - a ) α {P}_{cu} - β b \{ a / ( 1 - b ) \} {P}_{cu} \\ = {E}_{1} + \{ ( 1 - a ) α - β b a / ( 1 - b ) \} {P}_{cu} .\end{matrix}$$

On the other hand, in the current situation, when the basic portion is G₁ and the volume-based portion is G₂, then the current total gas rate RG_{cu} is expressed as

$$\begin{matrix}R {G}_{cu} = {G}_{1} + {G}_{2} \\ = {G}_{1} + γ {V}_{cu} ( {G}_{2} = γ {V}_{cu} ) .\end{matrix}$$

V_{cu} is the current consumption volume of gas. γ is coefficient for calculating the current gas rate. As for gas, the consumption increases after cogeneration is introduced because the amount used for the generator is added. This increment is expressed as G₃ in a formula described later. The merit of cogeneration is utilization of the exhaust heat from the generator. Water is fed to the generator, and heated there. The exhaust hot water is utilized in a kitchen, a bath room, a room heater and others. Therefore, portions of the gas rate consumed for these accommodations are made nothing after cogeneration is introduced. How much the gas rate decreases depends on how much proportion of gas consumption for the accommodations is in the whole gas rate. When this proportion is “c” (0<c<1), because the volume-based rate G₂ is reduced to (1−c)G₂, the post-introduction gas rate RG_{new} is expressed as

$$\begin{matrix}R {G}_{new} = R {G}_{cu} - c {G}_{2} + {G}_{3} \\ = {G}_{1} + {G}_{2} - c {G}_{2} + {G}_{3} \\ = {G}_{1} + ( 1 - c ) {G}_{2} + {G}_{3} \\ = {G}_{1} + ( 1 - c ) γ {V}_{cu} + {G}_{3} .\end{matrix}$$

The increment G₃ depends on the amount of power generated by the generator (how much gas is consumed per one-watt generation), i.e., G₃=δ P_{co}. Therefore,
RG_{new}=G₁+(1−c)γV_{cu}+δP_{co}.
Because P_{co}=a/(1−b)P_{cu} as described,
RG_{new}=G₁+(1−c)γV_{cu}+δa/(1−b)P_{cu}.
Finally, because a, b, c, α,β, γ, δ are all constants, the post-introduction power rate and gas rate can be calculated according to the current variable parameters, i.e., the current power-consumption volume P_{co} and the current gas-consumption volume V_{cu.}

Estimation of the total cost after introduction of cogeneration requires consideration of a cost for cogeneration equipment. Furthermore, there may be the case that a subsidy is paid by a local government promoting introduction of cogeneration. In this case, the amount of the subsidy must be deducted from the cost. Summarizing the above description, the pre-introduction total cost T_{cu} is expressed as

$$\begin{matrix}{T}_{cu} = R {E}_{cu} + R {G}_{cu} \\ = {E}_{1} + α {P}_{cu} + {G}_{1} + γ {V}_{cu}\end{matrix}$$

The post-introduction total cost T_{new} is expressed as

$$\begin{matrix}{T}_{new} = R {E}_{new} + R {G}_{new} + R - S \\ = {E}_{1} + \{ ( 1 - a ) α - β b a / ( 1 - b ) \} {P}_{cu} + \\ {G}_{1} + ( 1 - c ) γ {V}_{cu} + δ a / ( 1 - b ) {P}_{cu} + \\ R - S\end{matrix}$$

R is the monthly cost for cogeneration equipment, e.g., depreciation cost or lease charge. S is the monthly sum of a subsidy in the case it is paid.

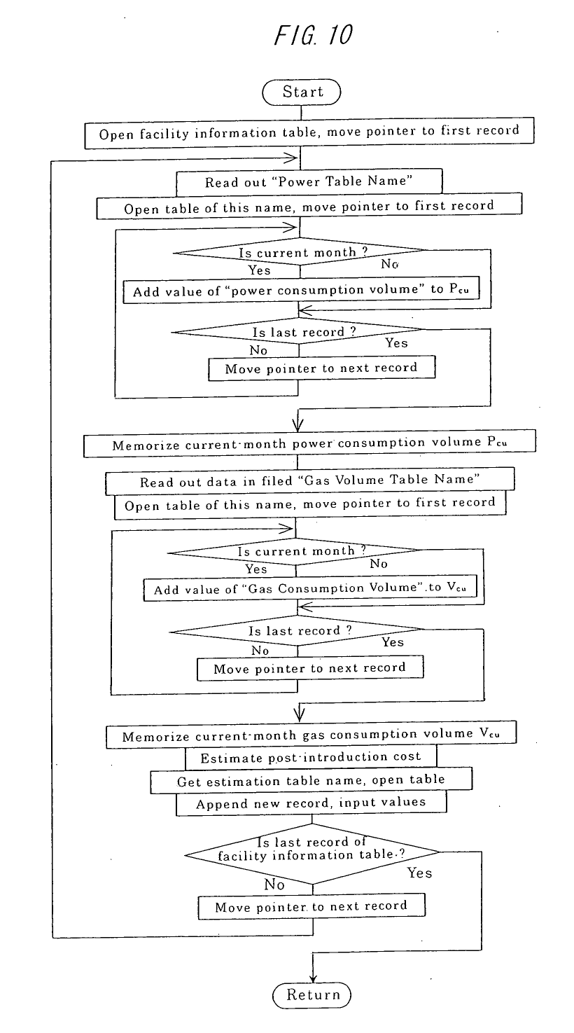

FIG. 10 is a flowchart schematically showing the estimation program. The estimation program is automatically executed once in every month, e.g., on the first day of every month. The estimation program initially opens the facility information table, and moves the pointer to the first record. Then, the estimation program reads out the data in the field of “Power Table Name”, and opens the facility power table of this name. The estimation program adds the data in the field “Watt-hour Data” successively, then gains the power consumption volume P_{cu} of the current month. In this, by utilizing the data in the field “Instantaneous Power”, the record of the current month is specified. The gained current-month power consumption volume is memorized in a memory variable temporarily.

Next, the estimation program reads out the data in the field “Gas Volume Table Name” in the current record of the facility information table, then opens the facility gas volume table of this name. The estimation program reads out and adds successively the data recorded in the field “Gas Volume Data”, then gains the current-month gas consumption volume V_{cu}. In this, records of the current month are specified by utilizing the data in the field “Data ID” as well. The gained current-month gas consumption volume V_{cu} is stored to anther memory variable temporarily. Next, the estimation program carries out the post-introduction cost estimation. A new record is appended in an estimation table. The result of the post-introduction cost estimation is recorded therein. An estimation table is created for every facility respectively in advance. Each of many records registered in each estimation table comprises fields of “Data Date-Time ID”, “Power Consumption Volume”, “Current Power Rate”, “Current Gas Rate”, “Current Total Cost”, “Post-Introduction Total Power Generation”, “Sold-Power Volume”, “Sold-Power Payment”, “Estimated Gas Increment”, “Estimated Gas Decrement”, “Estimated Power Rate”, “Estimated Gas Rate”, “Post-Introduction Total Cost”, “Sum of Cost Reduction”, and “Cost Reduction Ratio”.

In the field “Current Power Rate”, a value of the described the RE_{cu} is inputted. In the filed “Current Gas Rate” a value of the described RG_{cu} is inputted. A value of the described T_{cu} is inputted in the field “Current Total Cost”. A value of the described P_{co} is inputted in “Post-Introduction Total Power Generation”. A value of the described bP_{co} is inputted in “Sold-Power Volume”. A value of E₃(=β, bP_{co}) is inputted in “Sold-Power Payment”. A value of G₃(=δP_{co}) is inputted in “Estimated Gas Increment”. A value of c γV_{CU} is inputted in “Estimated Gas Decrement”. A value of the RE_{new} is inputted in “Estimated Power Rate”. A value of the RG_{new} is inputted in “Estimated Gas Rate”. A value of T_{new} is inputted in “Post-Introduction Total Cost”. Then, a value of T_{new}−T_{cu} is inputted in the field “Sum of Cost Reduction”. This is plus in the case of cost decrease, and minus in the case of cost increase. A value of (T_{new}−T_{cu})/T_{cu} is inputted in “Cost Reduction Ratio” as percentage.

After calculating the current power consumption volume P_{cu} and the current gas consumption volume V_{cu}, the estimation program searches the facility information table by the Facility ID as search key, then gets the estimation table name of the facility. After opening the table, the estimation program appends a new record and inputs each of the calculated values in each field thereof respectively. After appending the new record, the estimation program moves the pointer to the next record in the facility information table. Then, the estimation program repeats the same steps, finally appending a new record in the estimation table. Repeating these steps, the estimation program ends after the steps for the last record in the facility information table are carried out.

In the described data processing, the coefficient c is the proportion of the current gas consumption portion for hot-water supply and room heating. This value supposedly varies much through the seasons. For example, it may be about 0.1 in summer because no room heating is necessary. In winter, by contrast, it may be about 0.6 because a large amount of gas is consumed for room heating and hot-water supply. In spring and autumn, it may be medium, e.g., about 0.4. Though the coefficient c is determined experimentally from previous data, it would not differ from an actual value. Optionally, an extra gas meter may be provided for measuring reduction of the gas consumption for room heating and hot-water supply by introduction of cogeneration. Concretely, gas meters may be provided on a gas pipe for room heating and another gas pipe for hot-water supply. Data measured thereon are added up and transmitted separately from other measured data. Those are utilized as the described “−cG₂”. In the administrative client 501 connected to the data server 50 via LAN 500, a program for accessing the data server 50 and browsing objects managed by DBMS is installed. Therefore, the described estimation tables can be displayed and printed out on the administrative client 501.

As described, when a small-sized generator is introduced as cogeneration equipment, the post-introduction cost is estimated to be much below the pre-introduction cost in winter because exhaust heat from the generator is utilized for hot-water supply and room heating. In other seasons, by contrast, much cost reduction cannot be estimated. In other words, it is preferable to estimate a yearly cost after introduction of cogeneration. Considering this point, the system of this mode comprises a yearly cost estimation means carrying out cost estimation through a year. This means will be described in detail as follows.

The yearly cost estimation means comprises the data server 50 as hardware, and a yearly estimation program (hereinafter, YEP) installed in the hard disk of the data server 50. The YEP is executed by an access from the administrative client 501. In this, information about a facility name and a data period are inputted at the administrative client 501 and transmitted to the data server 50. The data period is a twelve-month period such as from January to December of a year, or from April to next March.

The YEP outputs a result of the yearly cost estimation into a format capable of being browsed by the administrative client 501. Because this format is called report in ACCESS of Microsoft Corporation, it is hereinafter mentioned as “yearly estimation report”. An OBF for the yearly estimation report is stored in the hard disk of the data server 50. A yearly estimation report shows the listing of data of a current total cost, a post-introduction total cost, a sum of cost reduction and others in a year of a facility.

The YEP initially searches the facility information table by a facility name as search key which is passed as argument, then gets the estimation table name of the facility. After opening the table of this name, the YEP designates a range of records by utilizing the column of “Data Year-Month” as the key, according to the data period passed as the argument. The YEP copies the records in the designated range and pastes them in a yearly estimation report. The YEP adds up the values in “Sum of Cost Reduction” in the designated range, and shows the result of it by the view of “Yearly Cost Estimation”. The YEP makes a graph of “Sum of Cost Reduction” in the designated range. The graphed data is shown in the yearly cost estimation table.

Operation of the described system will be described next. The following description is also a description about the cogeneration introduction simulation method as a mode. Each wattmeter 1 and each gas meter 2 provided in each facility measure power and gas volume consumed every day and every moment in each facility respectively. The measured data are integrated by the power integrator 13 and the gas volume integrator 33 into per-hour values respectively, then memorized in the memory of each transmitting processor 35. On the other hand, the TMP installed in the receiving processor 41 of the estimation means 5 makes a phone call every three hours to an external number of each global transmitter 3 of each facility, thereby making each global transmitter 3 transmit data memorized in each memory of each transmitting processor 35. The transmitted data are received by the global receiver 4 and memorized in the memory of the receiving processor 41 temporarily. Afterward, the decoding program and the transmission program installed in the receiving processor 41 are automatically executed. As a result, the data in the memory are converted into such a file as of CSV format, and stored at the predetermined path in the hard disk of the data server 50. After the transmission program is executed, the RDRP in the hard disk of the data server 50 is automatically executed by a command from the receiving processor 41. As a result, a data table is newly created. Afterward, the DAP is automatically executed, thereby appending new records respectively in each facility power table and each facility gas volume table both created for each facility.

With this, the operation every three hours ends. When another three hours passes, the same operation is repeated. The three-hours data memorized in the memory of the transmitting processor 35 are automatically deleted after the TMP is executed. Then, data of next three-hours are stored. On the other hand, an allowed person, e.g., administrative manager of this system, operates the administrative client 501 to access the data server 50. A desired estimation table is opened, then made on view by a display or printed out by a printer. If necessary, the YEP is executed, thereby making a view of a through-year cost estimation or printing out it.

By the method and system for simulating cogeneration introduction of the modes, a cost after introduction of cogeneration is automatically calculated from data of power and gas volume currently consumed in each facility. Therefore, necessity of cogeneration introduction can be evaluated accurately. Because a year-through cost estimation of cogeneration introduction is possible, the necessity can be evaluated more accurately.

In the described modes, the receiver 4 provided for the estimation means 5 may be one carrying out wire receiving. Specifically, some companies running wireless telephone business such as PHS are developing telemetry services. Those companies are also developing transmission services from relay stations via wire networks such as the Internet. Therefore, the estimation means 5 may comprise a computer connected to a wire network so that data of a power consumption volume and a gas consumption volume can be received thereby. In this, the data conversion into a highly universal format such as CSV may be carried out by a server of a telephone company.

In the above-described mode, it is preferable that both of the local transmitter 14 and the local receiver 34 are enabled by an internal communication function of Specified Small-Power Radio or PHS, because of no charge for the wireless communication therebetween. Because power consumption could fluctuate much, highly frequent transmissions may be required. Therefore, no charge for them is profitable. While the wattmeter 1 is often disposed inside a house, the gas meter 2 is often disposed outside a house. If a wire transmission means is employed to transmit out the both data together, a wiring through a wall of the facility would be required. Because of no need for such a troublesome work, wireless transmission is preferable. Though the data from the wattmeter 1 is locally transmitted in the described mode, substitutionally the data of the gas meter 2 may be locally transmitted, and transmitted globally together with the data from the wattmeter 1.

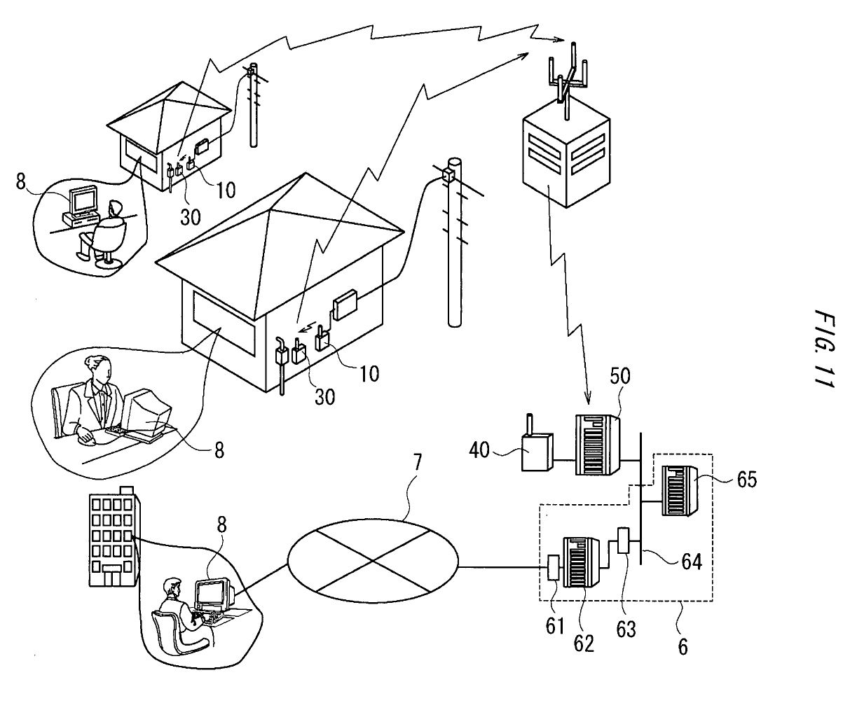

Nest will be described a method and system for promoting cogeneration equipment sale, as a mode of the invention. FIG. 11 is a view showing the schematic configuration of a cogeneration equipment sales promotion system. As well as the cogeneration introduction simulation system, the system shown in FIG. 11 comprises a wattmeter 1 provided in each facility to measure power consumption volume thereof, a gas meter 2 provided in each facility to measure gas consumption volume thereof, a transmitter 3 provided in each facility for radio transmission of the data measured at the wattmeter 1 and the gas meter 2, a receiver 4 to receive the data transmitted from the transmitter 3, and an estimation means carrying out cost estimation after introduction of cogeneration in each facility by the received data at the receiver 4. Description for those components is omitted because those are essentially the same as in the described cogeneration introduction simulation system.

The system shown in FIG. 11 further comprises an output means 6 to output a result of cost estimation by the estimation means. The output means 6 is one to output a result of cost estimation in a state that a salesperson of cogeneration equipment or an introduction decision maker can browse it. “Introduction decision maker” broadly means a person who is concerned in decision of cogeneration introduction. In this mode, the output means 6 transmits a file to a client computer 8 from the data server 50 when a salesperson or introduction decision maker operates the client computer 8 to access the data server 50 via a network. Specifically, the network is assumed to be the Internet 7 in this mode. The output means 6 comprises a web server (WWW server) 62 connected to the Internet 7 via a rooter 61. Via another rooter 63, the web server 62 is connected to an intranet (LAN) 64, on which the described data server is provided. The rooters 61, 63 and the web server 62 compose a firewall, shutting out unauthorized accesses to the intranet 64.

The web server 62 is a computer in which a web server software running on an OS such as UNIX (registered trademark) or Linux is installed. The web server 62 presents files for pages to be browsed vie the Internet 7, such as HTML, XML and others. These files are hereinafter simply mentioned as “page file”. The web server 62 comprises a common gateway interface (CGI) and CGI programs for data exchange with an authentication server 65 and the data sever 50. The authentication server 65 is provided on the intranet 64. One of authentication by the authentication server 65 is whether an output command of a cost estimation result is by an authorized person. The authentication server 65 comprises a database file where ID and passwords are registered. Each record in this database file includes data of “Customer ID”, which links this database file to a customer information table managed by the DBMS of the data server 50. The ID in the authentication server 65 is for browsing web pages. An ID and password are issued to each facility and each salesperson respectively. Each record of the database file in the authentication server 65 has a field in which a data to specify the ID holder is registered. This data is to discriminate whether the ID holder is a salesperson or introduction decision maker.

One of the page files stored in the hard disk of the web server 62 is for a top page, and another one is for a browse acceptance page. The browse acceptance page is to accept a browse demand of an estimation result. The top page includes input boxes of ID and password, and a send button. A CGI program for accepting a browse demand, hereinafter “browse demand acceptance CGI”, is embedded in the send button. When the send button is clicked, the browse demand acceptance CGI is executed. The browse demand acceptance CGI initially executes an authentication CGI program as subprogram, making the authentication server 65 judge whether the inputted ID and password are authentic. If authentic, the browse demand acceptance CGI sends the browse acceptance page to the client computer 8 and displays it thereon.

The browse acceptance page has layouts differing on salespersons or introduction decision makers. The layouts are common in having buttons of “monthly introduction cost estimation” and “yearly introduction cost estimation”. The layout for salespersons additionally has a box for selecting an estimation table of which facility is displayed. This box is hereinafter mentioned as “facility selection box”. Many OBF for tables managed by the DBMS are stored in the hard disk of the data server 50. One of them is for a person-in-charge information table, which is a database of salesperson information. Some others are for in-charge facility tables. Each in-charge facility table is a database of information about facilities which one salesperson is in charge of. Each of many records registered in the person-in-charge information table comprises fields of “ID”, “Person-in-Charge Name”, “Sales Office Name”, and “In-Charge Facility Table Name”. Each of many records registered in an in-charge facility table comprises fields of “Facility ID” and “Facility Name”.

Furthermore, an OBF for a connection table is stored in the hard disk of the data server 50. The connection table is to connect the ID of introduction decision makers and the Facility ID. Each of many records registered in the connection table is composed of “ID” of an introduction decision maker and “Facility ID” of the facility where he or she is entitled to decide the introduction. According to a data sent from the authentication server 65, the browse demand acceptance CGI judges whether the access from the client computer 8 is by a salesperson or by an introduction decision maker. If it is by a salesperson, the browse demand acceptance CGI searches the person-in-charge information table by the ID as search key, then gets the data of “In-Charge Facility Table Name”. The browse demand acceptance CGI opens the in-charge facility table of this name, reads out the data of the registered records, and displays them in the facility selection box in the browse acceptance page.

An CGI program to send data in an estimation table to a client computer 8 is installed in the hard disk of the web server 62. This CGI program is hereinafter mentioned as “estimation data sending CGI”. When the send button is clicked on the browse acceptance page, the browse demand acceptance CGI executes the estimation data sending CGI with the Facility ID as argument. In this, if the access is by an introduction decision maker, the browse demand acceptance CGI opens the connection table, searches it by the ID as search key, and gets the Facility ID. If the access is by a salesperson, the browse demand acceptance CGI makes him or her select it in the facility selection box. The facility selection box is, for example, a pull-down menu listing names of facilities which a salesperson is in charge of. When one of them is selected, the Facility ID of the facility is set to the argument.

When the button of “monthly introduction cost estimation” is clicked, the estimation data sending CGI searches the facility information table by the Facility ID as search key, then gets data of “Estimation Table Name” of the facility. The estimation data sending CGI opens the estimation table of this name, converts contents thereof into a predetermined format, e.g., HTML, XML or others, and sends them out. In this, a range of the data date-time may be designated for viewing. When the button of “yearly introduction cost estimation” is clicked, the estimation data sending CGI searches the facility information table by the Facility ID as search key as well, then gets “Yearly Estimation Table Name” of the Facility ID. The estimation data sending CGI opens the table of this name, and sends contents of it after the conversion into a predetermined format. The data of the cost estimation sent according to the access by an introduction decision maker are displayed on a client computer 8 disposed in the facility or another place. Those are utilized for a reference in deciding the introduction. The data sent according to the access by a salesperson is displayed on a client computer 8 disposed in a sales office or another place. Those are utilized as sales information.

This mode enables an introduction decision maker to browse a result of cost estimation after introduction of cogeneration into his or her facility. Therefore, necessity of the introduction can be judged easily. In this, there is no need for troublesome works such as measurements of the current power consumption volume and the current gas consumption volume, and calculation for the estimation. Those works are carried out by the system automatically. Therefore, the system is very convenient. Moreover, the system can help for a more accurate judgment because a yearly cost estimation result can be browsed as well.

For a salesperson, it is possible to browse a result of cost estimation after an introduction of cogeneration in a facility which he or she is in charge of. Therefore, it is possible to discriminate between facilities enjoying much cost reductions and other facilities not enjoying it. This helps for making his or her sales activity efficient. Therefore, the system is much preferable as a sales promotion tool. For example, it is possible to eliminate customers having higher potentials of introductions, and concentrates sales activities on them. Moreover, it is also possible to print out the data by a printer and present it to a customer. Therefore, a purchase of cogeneration equipment can be recommended more effectively. In this point as well, the system is much preferable for sales promotion of cogeneration equipment. Furthermore, because a yearly cost estimation result can be presented to a customer, more persuasive data are presented. As described, “introduction decision maker” has the broad meaning of “a person concerned in decision of a cogeneration equipment purchase in a facility. If the facility is of a company or organization, “introduction decision maker” may be a person in a section concerned in the cogeneration equipment introduction or entitled to the decision. If the facility is an ordinary house, it may by a person living therein.

Though the data of power and gas volume are transmitted by the transmitter 3 together in the described modes, those may be transmitted separately by a couple of transmitters. As for receiving as well, data may be received separately by a couple of receivers. Though post-introduction cost estimations for a multiplicity of facilities are calculated automatically, the effect may be the same even when a post-introduction cost estimation for one facility is carried out. Application to a multiplicity of facilities, still, has the effect of estimation expense reduction because the cost estimations are carried out commonly utilizing the cost estimation means and others. It leads to more efficient sales activities and reduction of sales expenses.

### INDUSTRIAL APPLICABILITY

As described, power consumption volume and gas consumption volume in a facility are automatically measured. The cost after introducing cogeneration is automatically calculated from the measured data. The extent of the cost reduction by the introduction is automatically calculated. Therefore, it is possible to judge necessity of the cogeneration introduction easily and accurately. Accordingly, the system and the method of the invention are utilized preferably for sales promotion of cogeneration equipment.

1] A cogeneration introduction simulation method carrying out a cost estimation after introducing cogeneration in a facility, comprising
a step for measuring power consumption volume in the facility by a wattmeter,
a step for measuring gas consumption volume in the facility by a gas meter,
a step for transmitting measured data of the power consumption volume and the gas consumption volume by a transmitter provided in the facility,
a step for receiving the data transmitted from the transmitter by a receiver, and
a step for estimating a cost after introducing cogeneration in the facility by an estimation means from the received data at the receiver.

2] The cogeneration introduction simulation method as claimed in the claim 1, further comprising a step for carrying out a year-through cost estimation by a year-through cost estimation means from the result of the estimation by the estimation means.

3] The cogeneration introduction simulation method as claimed in the claim 1, wherein the wattmeter is a single-phase two-wire type.

4] The cogeneration introduction simulation method as claimed in the claim 1, wherein the transmitter is a radio transmitter.

5] The cogeneration introduction simulation method as claimed in the claim 1, wherein
a local transmitter and a local receiver are provided in the facility in addition to the transmitter,
further comprising
locally transmitting the data of the power consumption volume measured at the wattmeter by the local transmitter,
locally receiving the data transmitted from the local transmitter by the local receiver, and
by the transmitter, transmitting out the data received at the local receiver together with the data of the gas consumption volume measured at the gas meter.

6] A cogeneration introduction simulation system carrying out a cost estimation after introducing cogeneration in a facility, comprising
a wattmeter provided in the facility to measure power consumption volume thereof,
a gas meter provided in the facility to measure gas consumption volume thereof,
a transmitter provided in the facility to transmit measured data of the power consumption volume and the gas consumption volume,
a receiver to receive the data transmitted from the transmitter, and
an estimation means for carrying out an cost estimation after introducing cogeneration in the facility from the received data at the receiver,
wherein
the estimation means comprises an estimation program carrying out the estimation for each facility according to the received data at the receiver.

7] The cogeneration introduction simulation system as claim in the claim 6, further comprising a year-through cost estimation means estimating a year-through cost from the result of the estimation by the estimation means.

8] The cogeneration introduction simulation system as claim in the claim 6, wherein the wattmeter is a single-phase two-wire type.

9] The cogeneration introduction simulation system as claimed in the claim 6, wherein the transmitter is a radio transmitter.

10] The cogeneration introduction simulation system as claimed in the claim 6, wherein
a local transmitter and a local receiver are provided in the facility in addition to the transmitter,
the local transmitter locally transmits the data of the power consumption volume measured at the wattmeter,
the local receiver locally receives the data transmitted from the local transmitter, and
the transmitter transmits out the data received at the local receiver together with the data of the gas consumption volume measured at the gas meter.

11] A cogeneration equipment sales promotion method outputting an estimation result so that a sales promotion of cogeneration equipment is carried out by informing a facility owner of the result of the estimation after introducing cogeneration in the facility, comprising
a step for measuring power consumption volume in the facility by a wattmeter,
a step for measuring gas consumption volume in the facility by a gas meter,
a step for transmitting measured data of the power consumption volume and the gas consumption volume by a transmitter provided in the facility,
a step for receiving the data transmitted from the transmitter by a receiver,
a step for estimating the cost after introducing cogeneration in the facility by an estimation program of an estimation means from the data received at the receiver, and
a step for outputting the cost estimation result by an output means,
wherein
the output means outputs the cost estimation result in a state of capability of being browsed by a salesperson selling cogeneration equipment to the facility, or by an introduction decision maker concerned in decision of a cogeneration equipment introduction to the facility.

12] The cogeneration equipment sales promotion method as claimed in the claim 11,
further comprising
a step for carrying out a year-through cost estimation by a year-through cost estimation means from the estimation result by the estimation means,
wherein
the output means outputs a result of the year-through cost estimation in a state of capability of being browsed by the salesperson or the introduction decision maker.

13] The cogeneration equipment sales promotion method as claimed in the claim 11, wherein the wattmeter is a single-phase two-wire type.

14] The cogeneration equipment sales promotion method as claimed in the claim 11, wherein the transmitter is a radio transmitter.

15] The cogeneration equipment sales promotion method as claimed in the claim 11, wherein
a local transmitter and a local receiver are provided in the facility in addition to the transmitter,
further comprising
locally transmitting the data of the power consumption volume measured at the wattmeter by the local transmitter,
locally receiving the data transmitted from the local transmitter by the local receiver, and
by the transmitter, transmitting out the data received at the local receiver together with the data of the gas consumption volume measured at the gas meter.

16] A cogeneration equipment sales promotion system outputting an estimation result so that a sales promotion of cogeneration equipment is carried out by informing a facility owner of the result of the estimation after introducing cogeneration in the facility, comprising
a wattmeter provided in the facility to measure power consumption volume thereof,
a gas meter provided in the facility to measure gas consumption volume thereof,
a transmitter provided in the facility to transmit measured data of the power consumption volume and the gas consumption volume,
a receiver to receive the data transmitted from the transmitter,
an estimation means for estimating a cost after introducing cogeneration in the facility from the received data at the receiver, and
an output means to output the cost estimation result by the estimation means,
wherein
the estimation means comprises an estimation program carrying out the estimation for each facility according to the received data at the receiver, and
the output means outputs the cost estimation result in a state of capability of being browsed by a salesperson selling cogeneration equipment to the facility, or by an introduction decision maker concerned in decision of a cogeneration equipment introduction to the facility.

17] The cogeneration equipment sales promotion system as claimed in the claim 16,
further comprising
a year-through cost estimation means for carrying out a year-through cost estimation from the estimation result by the estimation means,
wherein
the output means outputs a result of the year-through cost estimation in a state of capability of being browsed by the salesperson or the introduction decision maker.

18] The cogeneration equipment sales promotion system as claimed in the claim 16, wherein the wattmeter is a single-phase two-wire type.

19] The cogeneration equipment sales promotion system as claimed in the claim 16, wherein the transmitter is a radio transmitter.

20] The cogeneration equipment sales promotion system as claimed in the claim 16,
wherein
a local transmitter and a local receiver are provided in the facility in addition to the transmitter,
the local transmitter locally transmits the data of the power consumption volume measured at the wattmeter,
the local receiver locally receives the data transmitted from the local transmitter, and
the transmitter transmits out the data received at the local receiver together with the data of the gas consumption volume measured at the gas meter.
